(19) United States
(12) Patent Application Publication
(10) Pub. No.: US 2010/0030572 A1
(43) Pub. Date: Feb. 4, 2010

(54) TEMPORAL REGISTRATION OF MEDICAL DATA

(75) Inventors: Jens Von Berg, Hamburg (DE); Christian Lorenz, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/519,808

(22) PCT Filed: Dec. 12, 2007
(86) PCT No.: PCT/IB07/55054

§ 371 Date: Jun. 18, 2009

(30) Foreign Application Priority Data
Dec. 19, 2006 (EP) 06126494.1

(51) Int. Cl. G06Q 50/00

(52) U.S. Cl. 705/2

(57) ABSTRACT

A data structure for use by a computer system for comparing temporally varying medical data (9a, 9b) is disclosed. The data structure performs the steps of receiving a first data set (9a) including first data representing a medical parameter at a plurality of first times, receiving a second data set (9b) including second data representing said medical parameter at a plurality of second times, and processing said first and/or second data sets to increase a degree of correlation or similarity between a plurality of said first and second times representing identifiable events.

### FIELD OF THE INVENTION

The present invention relates to computer-aided diagnosis and more particularly, but not exclusively, to an apparatus and method for temporal registration of medical image data (using motion signatures).

### BACKGROUND OF THE INVENTION

Cardiovascular diseases are a very important cause of death in the industrial world. Their early diagnosis and treatment is crucial in order to reduce mortality and to improve patients' quality of life. Medical imaging and computer-aided diagnosis play an increasingly important role in assisting medical doctors, radiologists by providing useful information about, for example, internal organs of a patient. At present, non-invasive medical imaging procedures such as computer tomography (CT) or magnetic resonance imaging (MR) allow not only data acquisition of 3D images, which describe, for example, the cardiac anatomy, but also data acquisition of 4D image sequences (i.e. also containing a time component), which describe the cardiac anatomy and function.

To enable objective comparison between different medical image data sets of the same or different patients, image data registration is required. Also, in order to build an effective mean cardiac motion model using medical image data from many different patients, the data has to be registered not only in space but also in time. For example, to co-register individual beating hearts with each other in space, each one in its own patient coordinate system, a Procrustes analysis can be performed that transforms each patient coordinate system into a common model coordinate system and a mean model may be calculated in the model space by averaging the motion of identifiable landmark positions on the cardiac surface for a given cardiac phase point over all patients in the sample.

Typically, the cardiac cycle is depicted as a 100% full cycle beginning at the R-peak of an electrocardiogram (ECG) with an absolute duration of 1/r, where r is the heart rate. Thus, each phase point has a dedicated temporal position located between 0% and 100% of the cycle. However, this does not necessarily mean that a point representing identifiable events such as the end-systole (end of contraction phase) has such a dedicated position within the cardiac cycle. Causes for such temporal misalignment of physiological phase points might be due to differences in the acquisition parameters (e.g. trigger offset from R-peak and different intervals in the acquisition of consecutive frames), differences in the length of the cardiac cycles or differences in the dynamic properties of the heart. For example, the heart of one patient may have a longer contraction phase and a shorter relaxation phase than the heart of another patient. It is also known that with an increasing heart rate the duration of the systolic phase may not decrease as much as the duration of the diastolic phase, which could be a reason why identifiable events do not linearly correspond to a point in the R-R interval of the cardiac cycle.

FIG. 1 shows an example of motion signatures representing the mean displacement of landmarks (i.e. identifiable points on the heart) of various phase points of four different patients. The motion signatures are compensated for the influence of different heart rates using a method disclosed by Vembar et al. in Med. Phys. 2003 30(7) p. 1683ff. The peaks for the diastole and the peaks for the systole are clearly visible for each of the four different patients. While the temporal position of the diastole peaks agrees well between subjects at about 20% of the corrected R—R interval, the temporal position of the systole peaks varies significantly between subjects.

The example of FIG. 1 shows that the temporal alignment of the corresponding phase points to identifiable physiological events is not guaranteed, which might be a severe problem whenever two individual cardiac motion patterns are to be quantitatively compared to each other.

### SUMMARY OF THE INVENTION

Preferred embodiments of the present invention seek to overcome one or more of the above disadvantages of the prior art.

According to an aspect of the present invention, there is provided a data structure for use by a computer system for comparing temporally varying medical data, the data structure comprising computer code executable to perform the steps of:

receiving at least one first data set including first data representing a medical parameter at a plurality of first times;

receiving at least one second data set including second data representing said medical parameter at a plurality of second times; and

processing at least some of said first and/or second data to increase a degree of correlation between a plurality of said first and second times representing a respective plurality of identifiable events.

By processing first and second data representing a single medical parameter, this provides the advantage that the processing power needed is reduced, making the process of increasing a degree of correlation between a plurality of said first and second times significantly faster. For example, motion signatures of the heart are generated from predetermined landmarks for each patient and are registered with each other in order to estimate the time-warp between data in the different signatures representing identifiable events, thus allowing temporal alignment of the medical image data between different patients. The registration is therefore a one-dimensional process that is simpler in execution and therefore faster. It will be appreciated by persons skilled in the art that in the present context “correlation” means a degree of similarity between (i) the plurality of first times representing a series of identifiable or detectable events in one data set, and (ii) the plurality of second times representing the corresponding series of events in another data set.

Said medical parameter relates to at least one predetermined identifiable location in a patient.

This provides the advantage that a segmentation of the medical data already exists therefore simplifying the generation of said first and second data sets.

Said medical parameter may represent an average value displacement of a plurality of the identifiable locations.

This provides the advantage that important physiological events such as systole or diastole are identifiable within said first and second data set, therefore allowing temporal registration between different data sets.

The degree of correlation between a plurality of said first and second times may be increased by maximizing global similarity measure between said first and second data set.

The global similarity measure may include cross correlation and/or sum of squared distances of said first and/or second data points.

The step of processing said first and/or second data may includes adjusting at least one first and/or second time to increase said degree of correlation.

The computer code may be executable to limit the amount of which at least one said first and/or second time is adjusted.

Also, said first and second data sets are cardiac signature data.

According to another aspect of the present invention, there is provided a computer readable medium carrying a data structure as defined above stored thereon.

According to a further aspect of the present invention, there is provided a medical data processing apparatus for processing temporally varying medical data, the apparatus comprising at least one processor adapted to process a data structure as defined above.

According to a further aspect of the invention, there is provided a medical imaging apparatus comprising:

at least one imaging device for forming medical data;

a medical data processing apparatus as defined above; and

at least one display device for displaying representations of said first and second data sets after processing of said first and/or second data.

According to a further aspect of the invention, there is provided a method of comparing temporally varying medical data, the method comprising:

receiving at least one first data set including first data representing a medical parameter at a plurality of first times;

receiving at least one second data set including second data representing said medical parameter at a plurality of second times; and

processing at least some of said first and/or second data to increase a degree of correlation between a plurality of said first and second times representing a respective plurality of identifiable events.

### BRIEF DESCRIPTION OF THE DRAWINGS

A preferred embodiment of the present invention will now be described, by way of example only and not in any limitative sense, with reference to the accompanying drawings, in which:

FIG. 1 shows an example of motion signatures from 4 different patients with the vertical axis representing mean vertex displacement in [mm] and the horizontal axis representing a cardiac cycle between R—R peaks in [%];

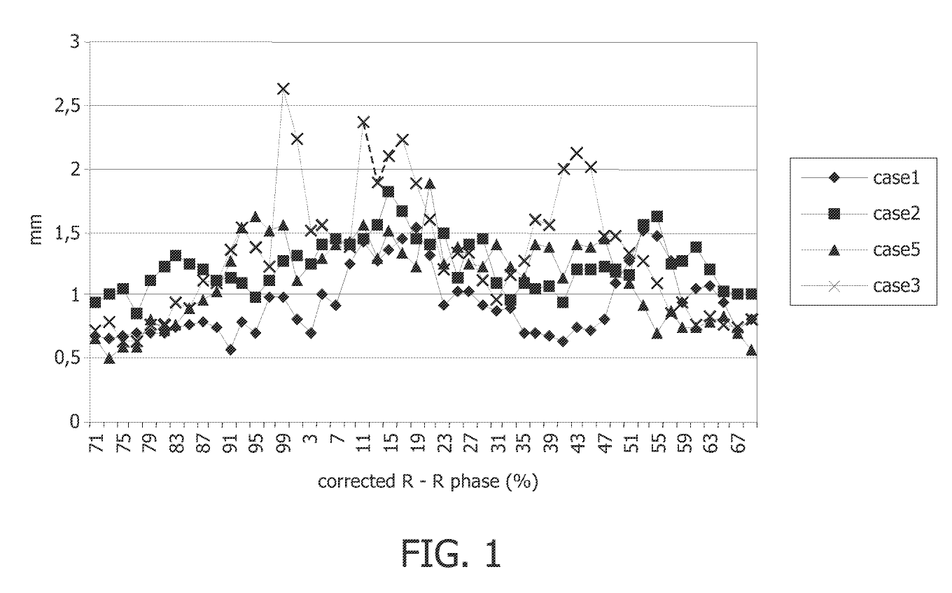

FIG. 2 is a diagrammatic representation of the components of a medical imaging data processing apparatus embodying the present invention; and

FIG. 3 is a flow diagram showing a method of processing medical image data embodying the present invention.

### DETAILED DESCRIPTION OF EMBODIMENTS

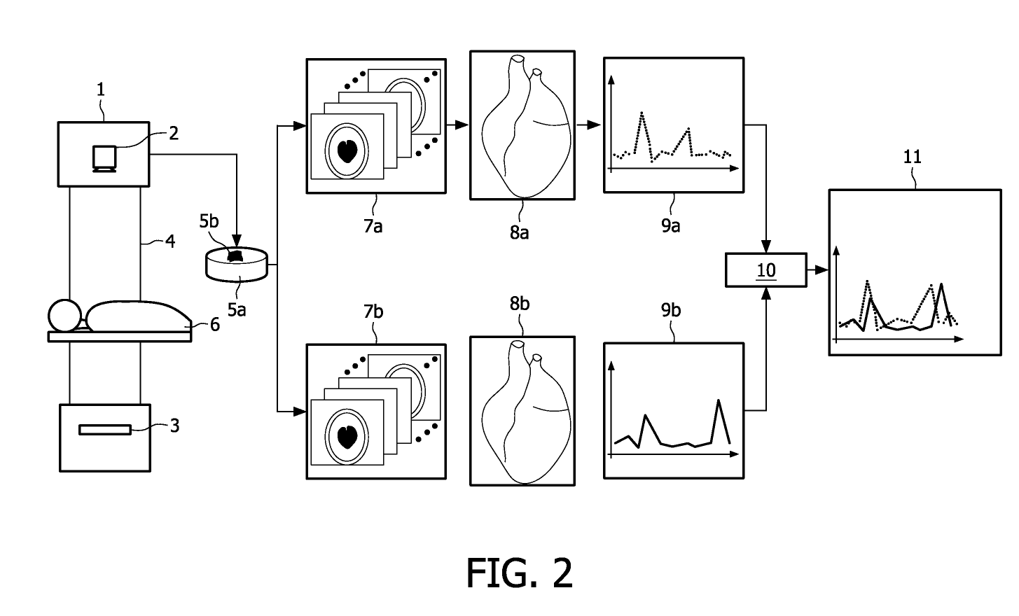

Referring to FIG. 2, a medical imaging data processing apparatus has a computer tomography (CT) imaging apparatus 1 including x-ray sources 2 and detectors 3 arranged in opposed pairs around a circular frame 4. A processor 5a processes the CT image data set of a patient 6 into 4D image sequences 7a and compares it with reference image data 7b from either the same patient at a different time, a different patient or a representative reference mean model. The processor 5a generates 3D images 8a and 8b including landmarks in each image of the series and spatially co-registers the different data sets 7a, 7b with each other. In addition, the processor 5a generates motion signatures 9a and 9b from the 3D image series 8a and 8b and executes a program 10 producing spatially and/or temporally aligned signatures which are displayed on a display device 11 enabling a physician or radiologist to directly compare the motion signatures and/or 4D image data sequences.

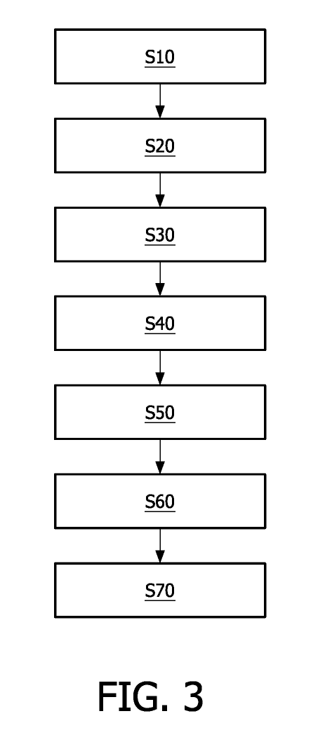

Referring to FIG. 3, the processor 5a obtains the image data of patient 6 and obtains reference image data at step S10. The processor 5a then generates a 4D data set from the patient 6 and reference data at step S20. At step S30, landmarks are identified using, for example, a shape tracking method and a 3D image data series 8a, 8b including the landmarks is produced for the patient 6 and reference data. At step S40, the processor 5a spatially aligns the 3D patient image data series 8a with the 3D reference image data series 8b and provides motion signatures for both 3D image data series at step S50. The motion signatures represent the average magnitude of displacement for all the identified landmarks. The processor 5a temporally aligns the motion signatures 9a and 9b of said patient 6 and reference image data 7a, 7b at step S60. In order to align the motion signatures with each other, Procrustes analysis may be used in the temporal domain.

The program 10 allows displacements of the given phase points of one or both motion signatures 9a, 9b in order to maximize the global similarity measure between the motion signatures 9a, 9b applying, for example, cross correlation and/or the sum of squared distances. The program 10 can also apply regularization constraints to avoid excessive local displacements of the phase points of the motion signatures 9a, 9b.

At step S70 the output produced by the processor 5a is displayed at a display unit 11.

The method described above allows, inter alia, for the comparison of beating patterns of two different hearts with respect to the physiological phase points instead of equidistant phase points in the R—R cycle or those just compensated using the heart rate. This improves the comparability of the temporal properties of the two beating hearts, but also allows a more accurate model building in the temporal domain, which may yield models with higher predictive value.

Instead of motion signatures any other signatures of the total motion pattern that reflects significant phase points may be used. For cardiac images, the left ventricular volume curve may be used instead, because it indicates systole and diastole of the left ventricle.

The same method is also applicable to other 4D image data sets of cyclic motion, such as respiratory motion, as well as complex non-cyclic motions, such as joint flexion engaging different muscles at different times. In addition, instead of the above used single valued motion signatures, multi valued signatures may be used.

It will be appointed to persons skilled in the art that the above embodiment has been described by way of example only, and not in any limitative sense, and that various alterations and modifications are possible without departure from the scope of the invention as defined by the appended claims.

1. A data structure for use by a computer system for comparing temporally varying medical data, the data structure comprising computer code executable to perform the steps of:
receiving at least one first data set including first data representing a medical parameter at a plurality of first times;
receiving at least one second data set including second data representing said medical parameter at a plurality of second times; and
processing at least some of said first and/or second data to increase a degree of correlation between a plurality of said first and second times representing a respective plurality of identifiable events.

2. A data structure according to claim 1, wherein said medical parameter relates to at least one identifiable location in a patient.

3. A data structure according to claim 2, wherein said medical parameter represents an average value of displacement of a plurality of said identifiable locations.

4. A data structure according to claim 1, wherein said degree of correlation between a plurality of said first and second times is increased by maximizing global similarity measure between said first and second data sets.

5. A data structure according to claim 4, wherein said global similarity measure includes cross correlation and/or sum of squared distances between points representing said first and second data.

6. A data structure according to claim 1, wherein the step of processing said first and/or second data includes adjusting at least one first and/or second time to increase said degree of correlation.

7. A data structure according to claim 6, wherein said computer code is executable to limit the amount of which at least one said first and/or second time is adjusted.

8. A data structure according to claim 1, wherein said first and second data sets are cardiac signature data.

9. A computer readable medium carrying a data structure according to claim 1 stored thereon.

10. A medical data processing apparatus for processing temporally varying medical data, the apparatus comprising at least one processor adapted to process the data structure of claim 1.

11. A medical imaging apparatus comprising:
at least one imaging device for forming medical data;
a medical data processing apparatus according to claim 10; and
at least one display device for displaying representations of said first and second data sets after processing of said first and/or second data.

12. A method of comparing temporally varying medical data, the method comprising:
receiving at least one first data set including first data representing a medical parameter at a plurality of first times;
receiving at least one second data set including second data representing said medical parameter at a plurality of second times; and
processing at least some of said first and/or second data to increase a degree of correlation between a plurality of said first and second times representing a respective plurality of identifiable events.
